(19) United States
(12) Patent Application Publication
(10) Pub. No.: US 2024/0411203 A1
(43) Pub. Date: Dec. 12, 2024

(54) PURELY OPTICAL LOGICAL NAND GATE WITH COMPRISING MATERIALS

(71) Applicants: Del Wolverton, Santa Rosa, CA (US); Kevin Joseph Bylow, Shelton, WA (US)

(72) Inventors: Del Wolverton, Santa Rosa, CA (US); Kevin Joseph Bylow, Shelton, WA (US)

(21) Appl. No.: 17/300,831

(22) Filed: Nov. 23, 2021

(51) Int. Cl. G02F 3/00; G06E 1/02

(52) U.S. Cl. CPC G02F 3/00; G06E 1/02

(57) ABSTRACT

A purely optical NAND logic gate is disclosed in this application where in various materials are employed to accomplish the functioning of the logic gate.

### FIELD OF THE INVENTION

This invention relates to a method of and apparatus for using a fiber optic logical NAND gate using optically active materials. NAND gates are used in computer and control device logic for the designing and programming of decision making circuits. The materials of this NAND gate allow all optical computational circuits to be designed.

### DESCRIPTION OF PRIOR ART

Much more information can be carried in fiber optic cables and light channels than in electrical wires. Many frequencies of light may be transmitted all carrying separate information or data in a fiber optic cable. The number of frequencies that may be sent on a single electrical wire is much more limited because the current waves on the wire do not stay separate because they share the same electrons. The electromagnetic fields of the light frequencies in a fiber optic cable or channel stay closely coupled and may be separated back to give their individual data stream. It is desirable there fore to develop fully optical logic and fully optical computing. It is to this end many patents have been written.

One patent that is an example of this is U.S. Pat. No. 7,995,877 by Skogen et al., which teaches “Optical NAND Gate” which was published Aug. 9, 2011. Skogen's AND gate is two photo detectors which are electrically connected so they only produce an optical output when they both receive a light signal. If a light signal is sensed by either photo detector with out the other also receiving a light signal, then no optical signal is passed on. Only when both photo detectors receive a light signal at the same time is an optical signal sent on. This is an optical AND gate. The output of this optical AND gate then goes to an optical NOT gate that works on transistor like semiconductor technology too. Transistors function by driving electrons through silicon by electrical fields. Transistors switch in nanoseconds. Skogen's NAND gate requires voltages to be applied to cause the NAND gate to function.

A second patent that is an example of prior art in the NAND gate technology is United States U.S. Pat. No. 8,330,960 by Ullrich et al., which teaches “All Optical and Hybrid Reflection Switch at a Semiconductor/Glass Interface Due to Laser Beam Intersection” which was published Dec. 11, 2012. In column 10 line 30 of Ullrich's patent, he tells how NOR and NAND gates may be made using his laser crossing technology. Ullrich's patent modulates one beam of laser light with another focused on the same point on a reflective surface. Both laser lights reflect at an angle from the perpendicular and one beam influences the brightness of the other beam. These arrangements are not parallel to the direction of the flow of the information. In column 13 line 4, an applied 6000 volts is used to invert the logic.

### SUMMERY OF THE NEW ART

Light signals enter three fiber optic channels. The first fiber optic channel is gate A of the optical logic gate providing the first digital data light input. The second fiber optic channel is gate B of the optical logic gate providing the second digital data light signal input. The third fiber optic channel is a source of light with the same power and frequency as the data light. In the AND gate, the light power of the input signal is divided in half so that only when both channels provide an input signals does a signal of sufficient power emerge from the AND gate to indicate a data light pulse. This provision of one pulse only when both A and B inputs contribute to the signal is a logical AND gate. These data light pulses then enter the logical NOT structure.

The data light pulse is divided in to two channels. The light in the channels are amplified in power to boost their power back to standard data pulse level. In one channel, the data pulse is doubled in frequency so it becomes a gate light control signal. The two channels are then combined and fed into a data light extinguisher in which the control light will turn off the data light signal if they are both present. In the present invention, no electrical control is required as Skogen's device does. The speed of the present new art data light extinguishing is much faster than nanoseconds. No applied voltage is needed. All of this is accomplished in a fiber optic channel and parallel to the path of data unlike Ullrich's device which requires reflecting at some angle from the normal to function. The present invention also does not require any 6000 volts to accomplish its function as Ullrich's does. Semiconductor circuits are killed by voltages as high as 6000 volts.

### BRIEF DESCRIPTION OF DRAWINGS

FIG. 1 shows an AND gate truth table

FIG. 2 shows a NAND gate truth table

FIG. 3 shows an optical schematic of the present inventions AND gate

FIG. 4 shows an optical schematic of the present inventions NAND gate

FIG. 5 shows a depiction of the atomic structure of the present inventions optical amplifier for optical signals

FIG. 6 shows a depiction of the atomic structure the present inventions data signal to control signal converter

FIG. 7 shows a depiction of the present inventions data light extinguishers atomic structure and light interaction

FIG. 8 shows a depiction of the present inventions filter for half powered light signals

### DETAILED DESCRIPTION OF NEW ART

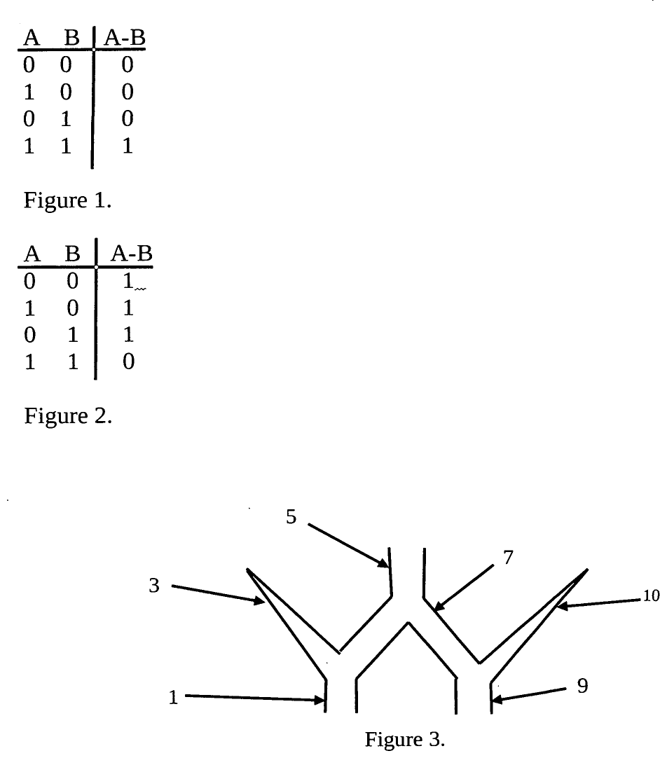

FIG. 1 shows a truth table for an AND logical gate. As seen in the truth table, when no light pulse enters either logic gate input channels A or B, the result is that no light signal or “1” comes out of the logical AND gate. When a light pulse enters gate input channel A and no light pulse or “1” enters gate input channel B, then no light signal or “1” comes out of the logical AND gate. The same is true if a light pulse enters gate input channel B and no light pulse enters or “1” gate input channel A, then no light signal or “1” comes out of the logical AND gate. Only when a light pulse enters both A and B logical gate input channels does a light pulse or “1” come out of the logical AND gate.

FIG. 2 shows a truth table for a NAND logical gate. When no light pulse enters either logic gate input channels A or B the result is a light pulse or “1” coming out of the logical NAND gate. If a light pulse enters either input channels A or B with no input pulse entering the other one, then a light pulse or “1” will come out of the logical NAND gate. Only if an input data signal goes into both input channels A and B does the logical NAND gate produce no output a “0” light pulse.

FIG. 3 shows the present inventions logical AND gate. Feature 1 is the A input for the AND gate pictured in FIG. 3. Feature 3 in FIG. 3 is a power reducer for input A of the AND gate. Feature 5 of FIG. 3 it is the AND output. Feature 7 is a combiner of the power reduced signal from input A and B. Feature 9 in FIG. 3 is input B for the AND gate pictured in FIG. 3. Feature 10 it is a power reducer for input B of the AND gate pictured in FIG. 3.

The AND gate in FIG. 3 takes in standard energy data light pulses and cuts their energy in half by way of the energy reduction structures 3 and 10. The light channels A and B are then recombined to produce the output data pulse. Only when both input channel A and B contribute their reduced energy pulses does the AND gate produce a standard energy pulse. This gives the result of the truth table shown in FIG. 1.

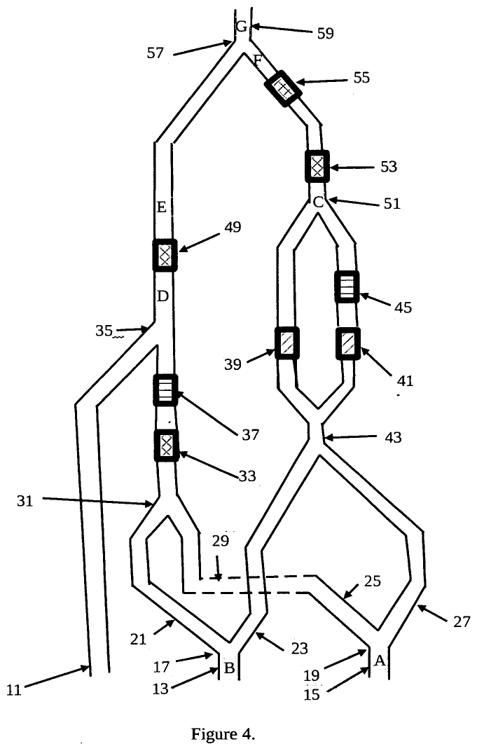

FIG. 4 is a schematic drawing of the NAND gate to be patented. In FIG. 4, features 11, 13, and 15 are the entrance gates for light signals for said NAND gate. Feature 15 is the A data gate for said NAND gate. Feature 13 is the B data gate for said NAND gate. Feature 11 is a supply of light identical in power and frequency with the data pulses that supplies the inverter part of said NAND gate. For illustration let there be an in put data of 00011100 coming into data gate A, and an input data of 00110000 coming into the data gate B. The output for the AND gate of the present invention which is feature 43 of FIG. 4 would then be 00010000 because only on the fourth data input do both A and B have a data signal of one. The output of said NAND gate should then be 11101111. Features 17 and 19 are splitting the data coming into Features 13 and 15 to reduce the power of the pulses so that only both together will have the power to be a data pulse for said AND and then said NAND gate. In this description of this invention, the term data light has been used to describe a light carrying information. In this description, control light will be used to indicate higher frequency light used to extinguish data light.

Features 21 and 25 carry half of the energy from Features 13 and 15, which are the B and A inputs of said NAND gate, to the data inverter for said NAND gate. Features 23 and 27 carry the data signals into said NAND gate. Feature 43 combines the input data light from Features 13 and 15. This combining makes the said AND gate portion of said NAND gate. Feature 29 is a light data channel that passes under light data channel 23 with out connecting. Feature 31 is a combiner for the light from features 29 and 21. Feature 33 is a half power signal filter that eliminates lower power pulse to provide only full power data pulse for the inverter. Feature 37 is a data signal to control signal converter for the data pulses coming from the half power signal filter 33. Feature 35 is a combiner for the light from input 11 and the output of said data signal to control signal converter Feature 37. Feature 49 is a data light extinguisher that acts so that when the light from 11 passes through said data light extinguisher 49, activated by control light from data signal to control signal converter Feature 37, the signal that results is an inversion of the data light exiting said AND gate. The control light from Feature 37 extinguishes the light from Feature 11 to leave zeros “0” in the light precisely where there were one “1” data light pulses in the data from the combined data from inputs A and B. So, when there is an AND pulse Feature 37 makes it a zero. In this embodiment of said NAND gate, doubled frequencies are used. In an alternative embodiment, other higher frequencies may be used. A 10 percent or 20 or other percentage higher frequencies may be used for the switching light.

The light channels are composed of higher index of refraction transparent material, and the channels are covered with lower index of refraction material to insure total internal reflection. The dimensions of the light channels are chosen so that the data light is near the cutoff frequency for the data light. When the piezoelectric features of the said data light extinguisher are actuated by the control light, the light channel becomes to small for the data light and it is cutoff.

Features 39 and 41 are optical amplifiers for the peaks coming from the combiner 43 for the input to the NOT part of said NAND gate. Feature 45 is a data signal to control signal converter for the light pulses coming from the AND part of said NAND gate. Feature 45 is a data signal to control signal converter that makes the data light into a control light with twice the frequency as the data light. If the data light has a frequency for example of 1.92E14 hertz (Hz) and a wavelength of 1560 nm, then the data light to control signal converter will change the data light into control light with a frequency for example of 3.85E14 Hz and a wavelength of 780 nm. Feature 53 is a data light extinguisher. The control light in the data light extinguisher causes a piezoelectric material to rise up and choke out the data light. This allows a “1” in the data signal to be changed to a “0” data signal. The control light must be a higher frequency that the data light. In this embodiment the said NAND gate the frequency is doubled, but in alternative embodiment a 10 percent higher frequency or 20 percent or other higher frequency may be used.

Feature 55 is a half power light filter. In the first part of the low power pulse filter, there are particle that disperse the light of light pulses so that half power pulses do not survive. In the second part of the low power pulse filter, there is a power pulse booster that builds standard data light pulses back to full strength after passing through the dispersion part of the low power pulse filter. When the light passes through Feature 55, only full power pulses survive. Feature 57 is a combiner of the output of the light from Feature 49 and the output of Feature 55. Feature 59 is the output of said NAND gate.

For writing signals that are data light of for example frequency 1.52E14 we have used “1s” and “0s.” For writing signals that are control light of for example frequency 3.85E14 we will use “{1s}” and “{0s}.” If the input into A is “00011100” and the input into B is 00110000, then at D the data will have been changed into a frequency doubled control of {00010000} by the action of Features 33 and 37. The {00010000} control will go into Feature 49 to produce a data signal at E of 11101111. The control of for example 3.85E14 Hz frequency light will extinguish the for example 1.52E14 Hz frequency data light in the one “1” data position leaving a zero “0.” This will be the required NAND gate output.

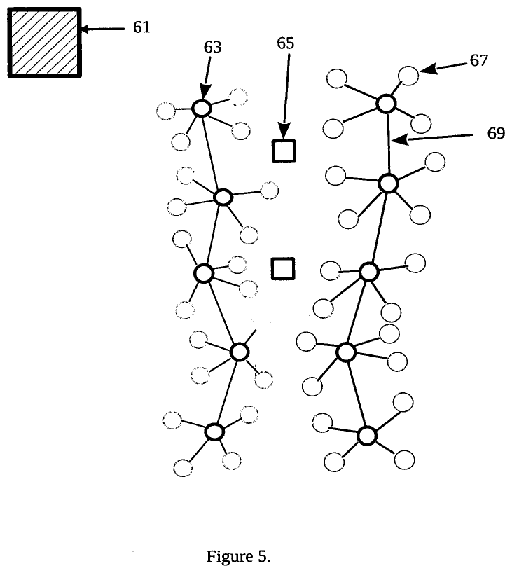

FIG. 5 is the detail of the materials of the optical amplifier shown in FIG. 4 in Features 39 and 41. Feature 61 is the diagram used for FIG. 4 in Features 39 and 41 to indicate said optical amplifiers. Feature 63 is an illustration of a silicon atom. Feature 65 is an illustration of a rare earth atom such as Erbium, Ytterbium, Neodymium or Praseodymium. Feature 67 is an illustration of a Hydrogen atom. Feature 69 is an illustration of a chemical bond. This illustration uses silicon oxide as a matrix for the rare earth atoms, but other matrix materials may be used in other embodiment's of this feature of this patent. Other matrix materials may be a room temperature vulcanizing (RTV) silicon rubber or a Phosphorus or Borax glass. The rare earth atoms lase and boost the power of the light data pulses passing through the optical amplifier material.

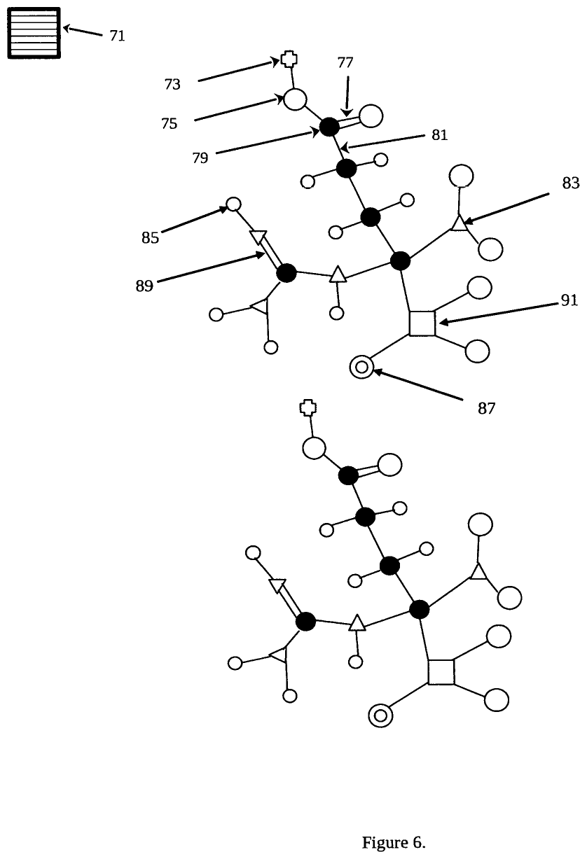

FIG. 6 is the detail of an example material of the data signal to control signal converter shown in FIG. 4 in Features 37 and 45. Feature 71 is the diagram used for FIG. 4 in Features 37 and 45 to indicate said optical amplifiers. The particular material shown here is one of many described in U.S. Pat. No. 4,876,688 written by Wang et al. which teaches “Frequency Doubling Crystals” which is here incorporated by reference. Feature 73 is an illustration of a Sodium atom. Feature 75 is an illustration of an Oxygen atom. Feature 77 is an illustration of a double chemical bond. Feature 79 is an illustration of a Carbon atom. Feature 81 is an illustration of a chemical bond. Feature 83 is an illustration of a Nitrogen atom. Feature 85 is an illustration of a Hydrogen atom. Feature 91 is an illustration of a Sulfur atom. Feature 87 is an illustration of a Fluorine atom. Feature 89 is a second double bond. This or other materials with this same characteristic will double for example 1.52E14 Hz frequency data light into for example 3.85E14 Hz frequency control light. This change in frequency will allow the control light to extinguish the data light in said data light extinguisher Features 49 and 53 in FIG. 4.

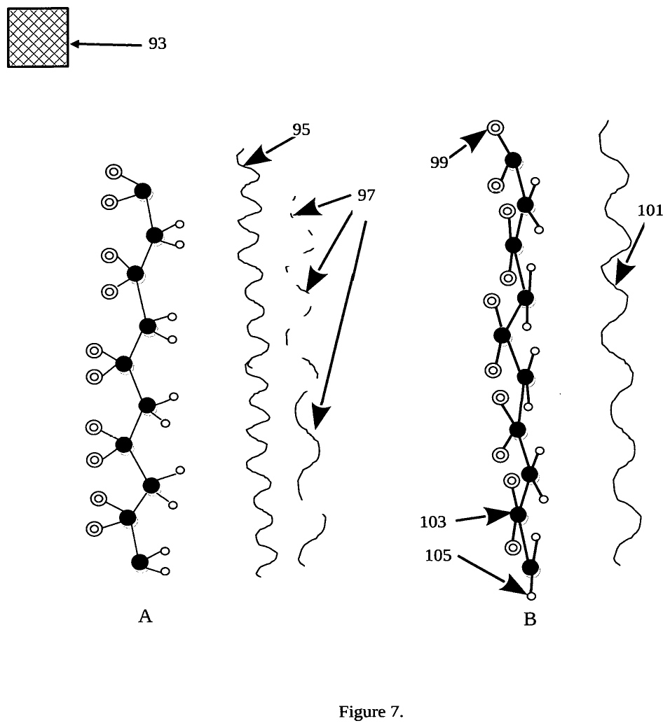

FIG. 7 is a detail of the material of the data light extinguishers shown in FIG. 4 in Features 49 and 53. Feature 93 is the diagram used in FIG. 4 for Features 49 and 53 to indicate said data light extinguishers. Example A in FIG. 7 is the data light extinguisher with control light of doubled frequency causing the piezoelectric material in the extinguisher to move and extinguish the data signal with the lower frequency. In FIG. 7, Example B is an illustration of the data light extinguisher with no double frequency control light to cause the piezoelectric material to move, and the data light passes through the data light extinguisher unhindered. In FIG. 7, Feature 95 is the double frequency control light. Feature 97 is the data light being extinguished by the motion of the piezoelectric material. Feature 101 is the data light passing through Example B of the data light extinguisher unhindered by the piezoelectric material in the data light extinguisher. Feature 99 is an illustration of a Fluorine atom. Feature 103 is an illustration of a Carbon atom. Feature 105 is an illustration of a Hydrogen atom. The molecule with piezoelectric properties illustrated here is polyvinylidene difluoride (PVDF). There are many other piezoelectric materials that could be used in this application. Materials like lithium niobate, lead zirconate titanate (PZT), trifluoroethylene (TrFE), or quartz crystal are also piezoelectric materials.

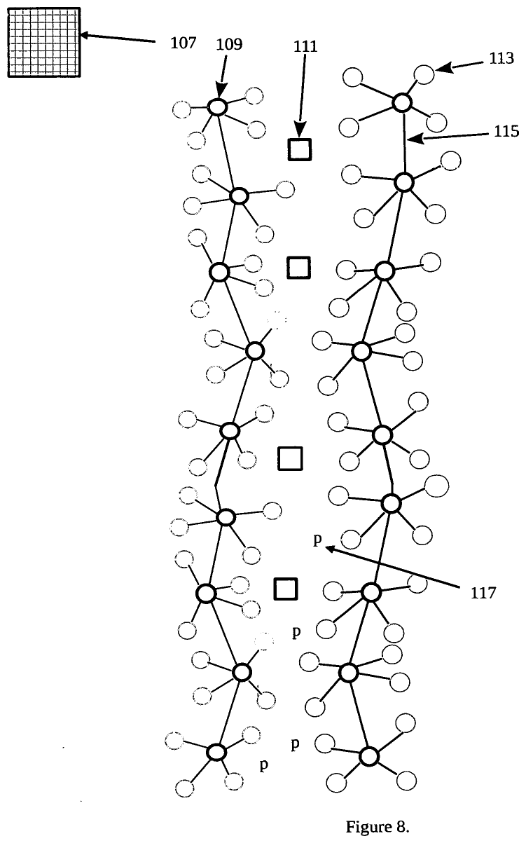

FIG. 8 is a detail description of said half power pulse eliminator seen in FIG. 4 in Features 33 and 55. In FIG. 8, feature 107 is the diagram used in FIG. 4 for features 33 and 55 to indicate half power light filter elements. Opaque particles are embedded in a matrix of transparent material. These particles disburse the light passing through and so to eliminate lower power pulses while allowing higher power pulses to survive. In this device after the power is disbursed, there are power booster rare earth atoms such as Erbium atoms to restore to the high power pulses to their original power once the low power pulses are completely eliminated. Feature 109 is an illustration of a Phosphors atom. Feature 113 is an illustration of an Oxygen atom. Feature 115 is an illustration of a chemical bond. Feature 111 is an illustration of a rare earth atom. Feature 117 is an illustration of a light dispersing particle. Light dispersing particles may be composed of Carbon, aluminum oxide, Sulfur, or other opaque material. In this illustration, a Phosphorus glass is used as a transparent matrix for this device. Other transparent matrix materials may be used in other embodiment of this invention. Materials are used such as RTV silicon rubbers, silicon oxide, or borosilicate glasses.

Following data pulses and control pulses through said NAND gate, the data starts in illustration points A and B seen in FIG. 4. Half of the energy of the inputs A and B is sent to combiner at feature 31. These data pulses then enter said half power signal filter feature 33 where only the full power pulses emerge to go on to said data signal to control signal converter feature 37. At illustration point D the light identical to data light from 11 and light from said data signal to control signal converter are combined. At illustration point E, control light from said data signal to control signal converter feature 37 has created and inverted signal from said light from supply input 11 through the function of said data light extinguisher feature 49. Said light at illustrative pint E is the inversion of the output of data light from said inputs A and B. At illustrative point C, light from said data signal to control signal converter Feature 45 and light from optical amplifier 39 are combined. At illustrative point F said NAND gate materials have produced no pulse for an input of signals from both A and B. At illustrative point G, the added pulses to fill in the data needed to meet the required NAND gate output, are present. The NAND gate truth table outputs are present in the output. The drawings provided in this disclosure are schematic only and actual equipment will have other features that are not necessary to the understanding of the present invention but those versed in the art will understand the added features needed.

I claim as my invention:

1. A purely optical NAND gate comprised of two input channels designated A and B with a third input of light for producing an inverted signal, two existing optical amplifiers, two data signal to control signal converters, two data light extinguishers, two low power pulse eliminators, light channels connecting said devices, with an exit light channel.

2. The utility of an optical amplifier claimed in claim one with lasing rare-earth atoms in a matrix material such as room temperature vulcanizing silicon rubber, silicon dioxide, phosphate glass, or boron glass matrix for suspending the lasing rare earth atoms that accomplish the amplification of light data signals.

3. The utility of an optical amplifier as claimed in claim one with rare-earth atoms such as Erbium, Ytterbium, Neodymium or Praseodymium are lasing to boost the signal of light.

4. A purely optical data signal to control signal converter as is claimed in claim one where the frequency doubling crystal may be one such as a chiral carbon molecules, potassium dihydrogen phosphate, lithium niobate, or lithium triborate.

5. A purely optical data signal to control signal converter as is claimed in claim one that increases the frequency of the data light to a higher frequency such as 10 percent higher, twenty percent higher, or some other percent higher frequency.

6. A purely optical data light extinguisher as claimed in claim one where the piezoelectric material such as polyvinylidene difluoride, lithium niobate, lead zirconate titanate (PZT), trifluoroethylene (TrFE), or quartz crystal that responds to said control light signal to close the light channel to the passage of the data light signal.

7. A purely optical low power pulse eliminator as claimed in claim one employing rare earth atoms such as Erbium, Ytterbium, Neodymium or Praseodymium.

8. A purely optical low power pulse eliminator as claimed in claim one employing a matrix material such as room temperature vulcanizing silicon rubber, silicon oxide, phosphate glass, or boron glass matrix for suspending the lasing rare earth atoms that accomplish the amplification of light data signals.

9. A purely optical low power pulse eliminator as claimed in claim one employing opaque particles that disburse data light pulses composed of materials opaque to the data light such as Sulfur, calcium carbonate, or aluminum oxide.

10. Light channels as is claimed in claim one comprised of higher refractive index light conducting material than the surrounding materials thus insuring total internal reflection of light in said light channel.

11. A purely optical process for managing digital light data signals A and B preforming a NAND gate logical function on said digital light data signals including a third input for a process of producing an inverted signal, including an existing optical amplifier, a process for converting data signals into control signals, a process for extinguishing data light, a process for eliminating low power pulses, and processes for containing said data light in optical channels.

12. A purely optical process is claimed as is claimed in claim eleven where higher frequency signals are generated from data light signals that may be slightly higher frequency, double frequency, or other amount of increased frequency.

13. A purely optical process is claimed as is claimed in claim eleven where higher frequency light closes a light channel to the passage of a data light signal making said channel smaller than the cutoff frequency dimension for said data light signal.

14. A purely optical process is claimed as is claimed in claim eleven for dispersing low power light pulses eliminating the low power light pulsed while boosting up standard power light pulses for use in a data stream.

15. A process is claimed as is claimed in claim eleven for maintaining total internal reflection of data and control light signals in a light channel that has dimensions near the cutoff frequency dimension for said data light.

16. A purely optical method for managing digital signals from inputs A, B, and a source of data like light to produce a NAND gate output using existing optical amplifiers, data signal to control signal converters, data light extinguishers, low power pulse eliminators, light channels connecting said devices, and an exit data signal port.

17. A purely optical method for using existing optical amplifiers as is claimed in claim sixteen comprised of lasing rare-earth atoms in a matrix material such as room temperature vulcanizing silicon rubber, silicon dioxide, phosphate glass, or boron glass matrix for suspending the lasing rare earth atoms that accomplish the amplification of light data signals.

18. A purely optical method for using existing optical amplifiers as is claimed in claim sixteen employing lasing rare-earth atoms such as Erbium, Ytterbium, Neodymium or Praseodymium that accomplish the amplification of data light signals.

19. A purely optical method for data signal to control signal converters as is claimed in claim sixteen employing frequency doubling materials such as chiral carbon molecules, potassium dihydrogen phosphate, lithium niobate, or lithium triborate.

20. A purely optical method for data light extinguisher as claimed in claim sixteen where the piezoelectric material such as polyvinylidene difluoride, lithium niobate, lead zirconate titanate (PZT), trifluoroethylene (TrFE), or quartz crystal that responds to said control light signal to close the light channel to the passage of the data light signal.
